(19) United States
(12) Patent Application Publication
(10) Pub. No.: US 2012/0306892 A1
(43) Pub. Date: Dec. 6, 2012

(54) MOBILE BALL TARGET SCREEN AND TRAJECTORY COMPUTING SYSTEM

(76) Inventor: Rongqing Hui, Lenexa, KS (US)

(21) Appl. No.: 13/482,287

(22) Filed: May 29, 2012

Related U.S. Application Data
(60) Provisional application No. 61/491,360, filed on May 31, 2011.

(51) Int. Cl. G06T 13/00

(52) U.S. Cl. 345/474

(57) ABSTRACT

A mobile target screen is described for ball game practicing and simulation. Tow force sensors are mounted at each of the four corners of the frame which holds a target screen. Measurements form the force sensors are used to compute and display a representation of ball speed, the location of the ball on the target screen, and the direction of the ball motion. These parameters can be used to predict the shooting distance and the landing position of the ball. It also provides enough information to predict the trajectory of the ball which can be displayed on a video screen which communicates with the sensors through a wireless transceiver.

### RELATED APPLICATIONS

The present US non-provisional patent application is related to and claims priority benefit of an earlier-filed provisional patent application titled “Mobile golf training device” 61/491,360. May 5, 2011. The identified earlier-filed application is hereby incorporated by reference into the present application, as though fully set forth herein.

### FIELD OF INVENTION

The present invention relates generally to golfing practice devices which predict the trajectory of a golf ball or any other type of ball hit, thrown or kicked into the target.

### BACKGROUND OF INVENTION

The ability to predict the trajectory of a golf ball is important in sport training as well as family entertainment. This type of apparatus is commonly referred to as a golf simulator. The prior art describes a number of techniques for predicting the trajectory of a golf ball hit from a specific location.

The first category of golf simulator is based on video cameras with high frame rates [1994/U.S. Pat. No. 5,342,051, 2011/U.S. Pat. No. 7,959,517], and the speed and the position of the golf ball can be measured through video capturing and image processing. Usually, a single video camera is not able to precisely measure the direction of the ball movement, so that arrays of video cameras have to be used, each filming from a different angle and position, to capture both the speed and the direction of the golf ball. In practice, the relative positions and angles of these video cameras have to be carefully arranged in order to correlate the images and compute the angle of the ball movement using image processing algorithms. Not only the computing software and image processing algorithms are complicated, the installation of multiple cameras also requires professional accuracy to assure the correct correlation of these images.

The second category of golf simulator is based on two-dimensional arrays of light sources and detectors in the tee area [1995/U.S. Pat. No. 5,437,457, 1998/U.S. Pat. No. 5,718,639]. The moving golf ball sequentially blocks the light from the sources to detectors and therefore the position of the ball can be detected as the function of time, so that the speed can be calculated. The complexity of this type of system is relatively high due to the use of large numbers of light sources and detectors, and the setup procedure also has stringent requirements on the positions of sources and detectors.

The third category of golf simulators is based on a mechanical setup in which a golf ball is hanging on the distal end of a rotating drum through an elongated cord [2012/U.S. Pat. No. 8,137,207]. When the golf ball is hit with a golf club, the impact force on the rotating drum and the frame which holds the drum can be measured so that the speed and the direction of the ball can be determined. In this case, the golf ball is mechanically tied to the rotating drum with a cord. Since the golf ball is not completely free, the experience of practicing would not be satisfactory.

The fourth category of golf simulators is based on measuring the impact of a golf ball hitting a screen. Miyahara [1995/U.S. Pat. No. 5,478,077] uses 4 microphones to detect collision sound when a ball hits a screen. Another microphone is used at the shooting point to detect the sound of the ball being hit. Based on the relative time of the sound signals received by these 5 microphones, the speed and the moving direction of the ball can be determined. In this technique, the 4 microphones on the screen can only determine the location of the ball on the screen, while the calculation of the speed and the direction of the ball rely heavily on the location of the tee with respect to the screen. The material to make the screen may also have to be special in order to produce the required sound.

Curchod [1993/U.S. Pat. No. 5,221,082] uses 4 force sensors, one on each corner of the screen, to measure the pressure force introduced when a golf ball hits the screen. A relatively large force is expected on a pressure sensor when the hitting point of the ball on the screen is close to that sensor. That is, dr·Fᵣ=dl·Fₗ, where dr and dl are distances between the ball hitting point and the right and the left sensor, respectively, and Fᵣ and Fₗ are pressure forces measured on the right and the left sensor, respectively. The same relation also holds for the top and the bottom sensors. Based on this, relative distance between the hitting point on the screen and each sensor can be calculated, so that the location of hitting point on the screen can be determined. Although the forces measured on the screen can determine the location of the ball hitting on the screen, its direction has to be calculated based on the location of the tee which is the starting point. Therefore, the measurements of the 4 force sensors on the screen have to be combined with the measurements of other optical sensors in front of the screen to predict the direction and the trajectory of the golf ball.

The purpose of the present invention is to provide a ball target screen which by itself, is able to determine both the position and the flying direction of a ball when it hits the screen. The apparatus will be simple enough for backyard practicing, requiring minimum setup complexity.

### BRIEF DESCRIPTION OF THE INVENTION

The current invention is intended to provide a target screen which has the ability to detect the speed and location of the ball hitting on it, as well as the flying direction of the ball. This allows the reconstruction of the trajectory of the ball and the prediction of the shooting range and the location of the landing point.

In one embodiment the four corners of the target screen are tied to a rigid frame. Two force sensors are used at each corner. Upon the event when a ball hits the target screen, the momentum exerted on the target screen creates a vector force on each corner. The two force sensors are amounted in the way they measure forces in the orthogonal (vertical and horizontal) directions. This allows the determination of the force vector produced at each corner of the target screen. Based on the force vectors simultaneously measured from the four corners of the target screen, the location, the speed and the flying direction of the ball can be calculated. There is no need to know the location of the tee where the ball started. This is fundamentally different from the prior art [1993/U.S. Pat. No. 5,221,082], where one sensor is used on each corner which is only able to measure the scalar force, and as a consequence the flying direction of the ball cannot be determined.

The force vectors measured by the 8 sensors are collected and communicated with a calculation and display unit through a wireless transceiver. Since the trajectory of the ball can be determined by the target screen and force sensors alone and no other information, such as the location of the tee or the initial speed of the ball after impact from the golf club, this invention is especially suitable for low budget and mobile applications requiring fast setup and easy operation.

These and other features of the present invention are discussed in detail in the section titled DETAILED DESCRIPTION, below.

### BRIEF DESCRIPTION OF THE DRAWINGS

The drawings constitute a part of this specification and include exemplary embodiments of the disclosed subject matter illustrating various objects and features thereof, wherein like references are generally numbered alike in the several views.

FIG. 1, Illustrates the configuration of the target screen which is composed of a rigid frame, a soft screen and 8 sensors at the 4 corners.

FIG. 2, Illustrates the embodiment of converting the pulling force from the target screen into force on sensors using a mechanical structure.

FIG. 3, Illustrates the embodiment of converting the pulling force from the target screen into force on the sensors using a spherical or round structure inside an enclosed box.

FIG. 4, Illustrates the static force f_{DC} versus dynamic force (f(t)−f_{DC}) when a ball hits the screen.

FIG. 5, Illustrates the forces measured by the force sensors and the location of the ball on the screen.

FIG. 6a, Illustrates a 3-dimensional description of the speed vector. Where φ_{V} is the angle between \vec{v}₀ and the horizontal xy plane and φ_{H} is the angle projected on the horizontal plane and the z-axis.

FIG. 6b, Illustrates a 2-dimensional description of the speed vector \vec{v}₀ projected on the yz′ plane. Where z′ is the direction of \vec{v}₀ projected on the horizontal xy plane.

FIG. 7, Illustrates the 3-D trajectories of the ball with the initial velocity V₀=20 m/s, be h₀=0.5 m and the angles are (f_{V}=45°, f_{H}=18°), (f_{V}=45°, f_{H}=0°), and (f_{V}=30°, f_{H}=−18°), respectively.

FIG. 8, Illustrates the spin of the ball through the difference of two speed vectors \vec{v}₀ and \vec{v}ₐ.

### DETAILED DESCRIPTION

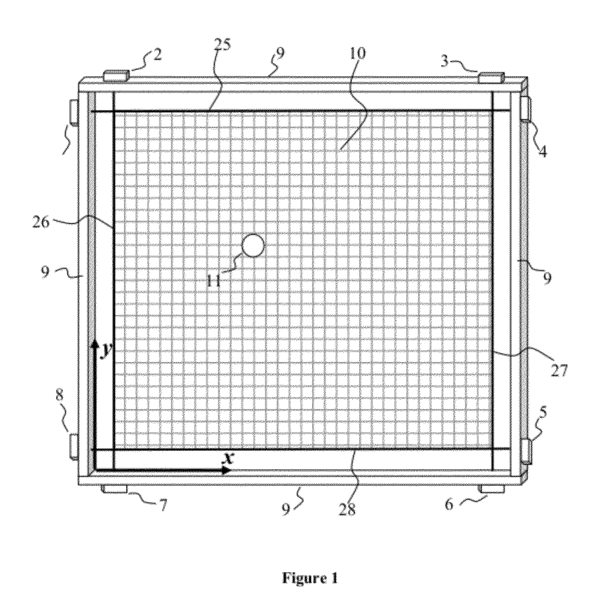

The purpose of the present invention is to provide a simple and mobile target screen which is able to detect the speed, the location and the flying direction of a ball 11 when it hits the screen 10. As shown in FIG. 1, the screen 10 is tied on a rigid frame 9 through the four corners. A total of eight force sensors (1, 2, 3, 4, 5, 6, 7, 8) are affixed to the frame 9, two at each corner and operably attached to the screen 10. Force sensor 1 measures the force of the screen applied on the top left corner of the frame 9 towards the horizontal right (+x) direction, whereas force sensor 2 measures the force at the same corner of the frame 9 but towards the veridical downward (−y) direction. Similarly, pressure sensor pairs (4, 3), (5, 6), and (8, 7) measure forces of the screen exerted on the other 3 corners of the frame 9 in the horizontal and vertical directions respectively.

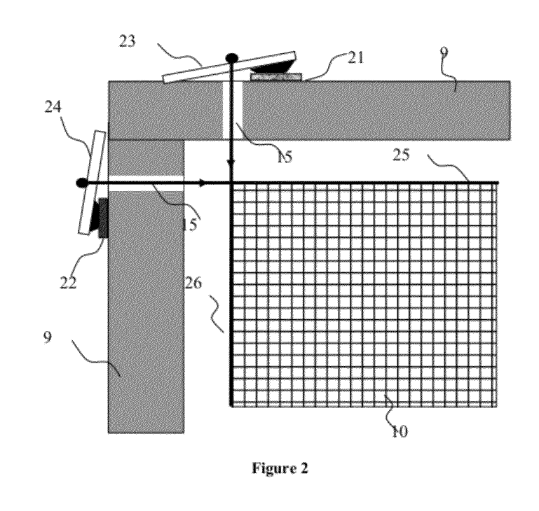

An electro-mechanical force sensor is a device whose conductance or electrical current is proportional to the mechanical force applied on its sensing area. Force sensors can be low-cost and miniature in size. In order to utilize force sensors in the current apparatus, the stretching forces of the strings 25, 26, 27 and 28 which hold the screen 10 have to be converted into forces which can be measured by respective force sensors 1-8. One embodiment for such configuration is illustrated in FIG. 2, which illustrates the top right corner configuration of the frame 9. Each of the strings 25, 26, 27 and 28 which holds the corner of the screen 10 in a certain direction (horizontal or vertical) passes through a via 15 in frame (9) and is secured to a short piece of rigid bar 24. The forces pulling on the strings 25 and 26 are transferred to the pressure force on sensors 1 and 2.

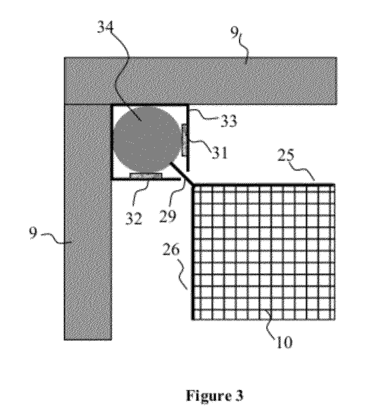

Another embodiment of the force sensor configuration is shown in FIG. 3, which illustrates the top right corner configuration of the frame 9, in which a solid ball or a solid disk 34 is enclosed inside a box 33. One end of a string 29 is attached to the ball/disk 34 and the other end of the string 29 is attached on the corner of the screen 10. Force sensors 1 and 2 are mounted on the inside walls of the box 33 in the vertical and horizontal directions, respectively. The pulling forces of the screen in the vertical and horizontal directions are transferred to pressure force on sensors 1 and 2. The force sensor can be a low-cost force-sensitive resistor (such as standard 402 FSR from Interlink Electronics, or Flexiforce A201 pressure sensor from Tekscan). In these semiconductor-based force-sensitive resistors, the conductance is proportional to the force applied on the active area. With a proper electrical biasing, the force can be converted to an electrical voltage signal. Other types of force sensors can also be used.

At the moment when a golf ball hits the screen, the force produced on all of the force sensors 1-8 can be simultaneously measured. The speed of the ball, the location of the ball on the screen and the flying direction of the ball can all be determined by the force values measured on the sensors 1-8, which is further described below.

### Determining the Speed of a Flying Ball

Assume a golf ball 11 has a mass m and a speed V₀. When it hits the screen, its momentum will be reduced from mV₀ to zero within a relatively short time interval, that is,

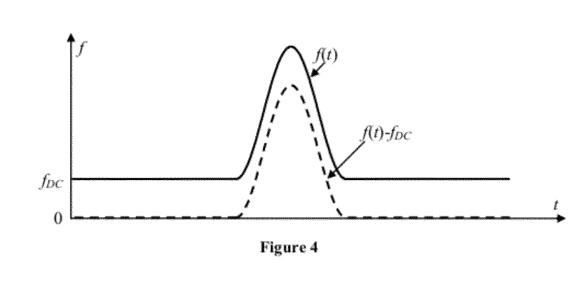

F=∫f(t)dt=mV₀ Equation (1)

Where, f(t) is the instantaneous force on the target screen 10 which is, in general, a function of time t, and F is the integrated value of the force over time. In practice, the force values measured by the force sensors 1-8 will not be zero even without the ball 11 hitting the screen 10. The static force f_{DC} on each force sensor is determined by the tightness of the screen 10 fixed to the frame 9 which often depends on installation. FIG. 4 illustrates the force f(t) on a pressure sensor as the function of time during the event when a ball 11 hits the screen 10. As long as the force sensor (1-8) response is linear, the static force f_{DC} can be subtracted in signal processing in which only the time varying component of the force is considered in the integration.
Based on equation (1) the speed of the ball 11 can be found by the overall force exerted on the screen 10, that is,

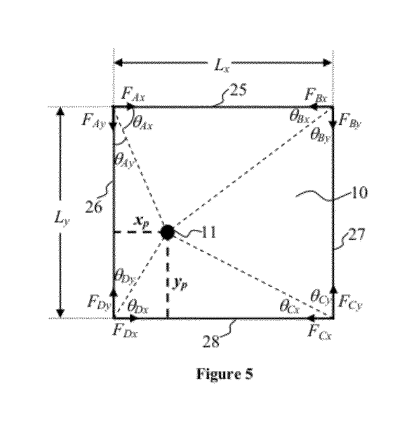

V₀=B(F_{Ax}+F_{Ay}+F_{Bx}+F_{By}+F_{Cx}+F_{Cy}+F_{Dx}+F_{Dy}) Equation (2)

Where, B is a proportionality factor depending on the force sensor 1-8 characteristics, and the mass of the ball 11, which can be calibrated. Assume F_{Ax}, F_{Ay}, F_{Bx}, F_{By}, F_{Cx}, F_{Cy}, F_{Dx}, and F_{Dy} are the integrated force values measured by the 8 sensors 1, 2, 3, 4, 5, 6, 7, and 8 at the four corners as shown in FIG. 5, the position of the ball on the screen can be deduced from these values as described below.

### Position of the Ball on the Screen

As shown in FIG. 5, if the bottom-left corner of the screen is used as the origin (0, 0), the position (xₚ, yₚ) of the ball on the screen can be calculated based on the force values F_{Ax}, F_{Ay}, F_{Bx}, F_{By}, F_{Cx}, F_{Cy}, F_{Dx}, and F_{Dy} measured by the sensors. Suppose the length and the width of the screen are Lₓ and L_{y}, respectively, when a golf ball 11 hits the screen 10 at the location (xₚ, yₚ), the angles shown in FIG. 5 can be calculated based on the following basic trigonometry relations,

$$\begin{matrix}{θ}_{Ax} = {tan}^{- 1} ( \frac{{F}_{Ay}}{{F}_{Ax}} ) & Equation ( 3 a ) \\ {θ}_{Ay} = {tan}^{- 1} ( \frac{{F}_{Ax}}{{F}_{Ay}} ) & Equation ( 3 b ) \\ {θ}_{Bx} = {tan}^{- 1} ( \frac{{F}_{By}}{{F}_{Bx}} ) & Equation ( 3 c ) \\ {θ}_{By} = {tan}^{- 1} ( \frac{{F}_{Bx}}{{F}_{By}} ) & Equation ( 1 d ) \\ {θ}_{Cx} = {tan}^{- 1} ( \frac{{F}_{Cy}}{{F}_{Cx}} ) & Equation ( 3 e ) \\ {θ}_{Cy} = {tan}^{- 1} ( \frac{{F}_{Cx}}{{F}_{Cy}} ) & Equation ( 3 f ) \\ {θ}_{Dx} = {tan}^{- 1} ( \frac{{F}_{Dy}}{{F}_{Dx}} ) & Equation ( 3 g ) \\ {θ}_{Dy} = {tan}^{- 1} ( \frac{{F}_{Dx}}{{F}_{Dy}} ) & Equation ( 3 h )\end{matrix}$$

### Since

$$\frac{{y}_{p}}{{L}_{y} - {y}_{p}} = \frac{tan ( {θ}_{AY} )}{tan ( {θ}_{DY} )} ,$$

the vertical position of the ball 11 on the screen 10 is,

$${y}_{p} = {L}_{y} \frac{tan ( {θ}_{Ay} )}{tan ( {θ}_{Ay} ) + tan ( {θ}_{Dy} )} = {L}_{y} \frac{{F}_{Ax} {F}_{Dy}}{{F}_{Ax} {F}_{Dy} + {F}_{Dx} {F}_{Ay}} \qquad Equation ( 4 a )$$

Similarly, the horizontal position of the ball 11 on the screen 10 is

$${x}_{p} = {L}_{x} \frac{{F}_{Cy} {F}_{Dx}}{{F}_{Cy} {F}_{Dx} + {F}_{Dy} {F}_{Cx}} \qquad Equation ( 4 b )$$

The location of the ball 11 (xₚ, yₚ) on the screen 10 can also be found using:

$$\begin{matrix}{y}_{p} = {L}_{y} \frac{{F}_{Bx} {F}_{Cy}}{{F}_{Bx} {F}_{Cy} + {F}_{Cx} {F}_{By}} & Equation ( 5 a ) \\ {x}_{p} = {L}_{x} \frac{{F}_{By} {F}_{Ax}}{{F}_{By} {F}_{Ax} + {F}_{Ay} {F}_{Bx}} & Equation ( 5 b )\end{matrix}$$

In fact, equations (4) and (5) are redundant; they calculate the same location parameters but using force values measured from different sets of sensors. The average of these two sets of measurements allows reduction in the impact of the measurement errors.

### Traveling Direction of the Ball

First consider the simplest condition that a golf ball 11 hits the screen 10 perpendicularly (to the forward direction). There is no momentum change in the horizontal direction when the ball 11 is stopped by the screen, and therefore the sum of the measured vector forces on the screen in both the horizontal (x) direction and the vertical (y) direction should be zero, that is, F_{Ax}+F_{Dx}=F_{Bx}+F_{Cx} and F_{Ay}+F_{By}=F_{Cy}+F_{Dy}.

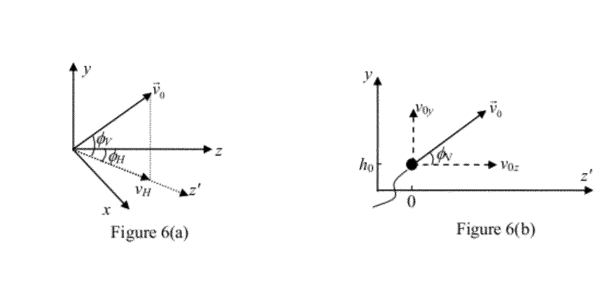

In general, the speed vector of a ball \vec{v}₀ can be defined by its speed V₀ and an angle φ with respect to the forward direction z (where z is perpendicular to the xy plane). As illustrated in FIG. 6, this angle can be further decomposed into a horizontal angle φ_{H} and a vertical angle φ_{V}.

Obviously, φ_{H} is determined by the horizontal momentum of the ball, which is proportional to the normalized differential force in the horizontal direction. The horizontal angle φ_{H} can be found as,

$${φ}_{H} = M [ \frac{( {F}_{Ax} + {F}_{Dx} ) - ( {F}_{Bx} + {F}_{Cx} )}{( {F}_{Ax} + {F}_{Dx} ) + ( {F}_{Bx} + {F}_{Cx} )} ] \qquad Equation ( 6 a )$$

Where, M is a proportionality constant, which depends on the friction between the golf ball 11 and the target screen 10, as well as the fidelity of the force sensors 1-8. This proportionality constant can be calibrated experimentally after the mobile target screen system is fabricated. Similarly, the vertical angle can be found as,

$${φ}_{V} = M [ \frac{( {F}_{Ay} + {F}_{By} ) - ( {F}_{Cy} + {F}_{Dy} )}{( {F}_{Ay} + {F}_{By} ) + ( {F}_{Cy} + {F}_{Dy} )} ] \qquad Equation ( 6 b )$$

Note that the angles φ_{H} and φ_{V} may either be positive or negative representing the case when the ball 11 travels to the left/right or high/low with respect to the surface normal to the target screen 10.

### Flying Trajectory Prediction of the Ball

As illustrated in FIG. 6, assume the ball 11 has a mass m, a velocity V₀ and a height h₀ upon hitting the screen, its vertical velocity is,

v_{y}(t)=V₀ sin(φ_{V})−gt Equation (7)

Where, g=9.8 m/s² is the gravity. The distance traveled in the vertical direction is then,

y(t)=h₀+∫v_{y}(t)dt=h₀+V₀ sin(φ_{V})t−½gt² Equation (8)

After a time T, the ball 11 falls to the ground, that is, h₀+v₀ cos(φ_{V})T−½gT²=0

$$T = \frac{2 {V}_{0} sin ( {φ}_{V} ) + \sqrt{4 {V}_{0}^{2} {sin}^{2} ( {φ}_{V} ) + 8 {gh}_{0}}}{2 g} \qquad Equation ( 9 )$$

Within this time, the ball 11 travels in the z′-direction for a distance of,

$${L}_{{z}^{′}} = {v}_{0} cos ( {φ}_{V} ) T = {V}_{0} cos ( {φ}_{V} ) \frac{2 {V}_{0} sin ( {φ}_{V} ) + \sqrt{4 {V}_{0}^{2} {sin}^{2} ( {φ}_{V} ) + 8 {gh}_{0}}}{2 g} \qquad Equation ( 10 )$$

During this time interval T, the ball 11 travels in the x-direction for a distance of,

$${L}_{x} = {V}_{0} sin ( {φ}_{H} ) T = {V}_{0} sin ( {φ}_{H} ) \frac{2 {V}_{0} sin ( {φ}_{V} ) + \sqrt{4 {V}_{0}^{2} {sin}^{2} ( {φ}_{V} ) + 8 {gh}_{0}}}{2 g} \qquad Equation ( 10 )$$

If the initial height is negligible and let h₀=0, this distance expression can be simplified as,

$$\begin{matrix}{L}_{{z}^{′}} = \frac{2 {V}_{0}^{2} cos ( {φ}_{V} ) sin ( {φ}_{V} )}{g} = \frac{{V}_{0}^{2} sin ( 2 {φ}_{V} )}{g} & Equation ( 12 ) \\ {L}_{x} = \frac{2 {V}_{0}^{2} sin ( {φ}_{H} ) sin ( {φ}_{V} )}{g} & Equation ( 13 )\end{matrix}$$

The detailed trajectory of the ball 11 can be found by its position at any time described as,

y(t)=h₀+V₀ sin(φ_{V})t−½gt² Equation (14a)

z(t)=V₀ cos(φ_{H})cos(φ_{V})t Equation (14b)

x(t)=V₀ sin(φ_{H})cos(φ_{V})t Equation (14c)

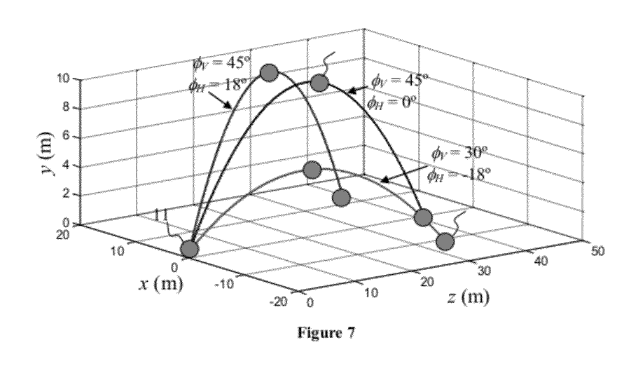

FIG. 7 shows a 3-dimensional display of the ball 11 trajectories with the initial velocity V₀=20 m/s and the angles are (f_{V}=45°, f_{H}=18°), (f_{V}=45°, f_{H}=0°), and (f_{V}=30°, f_{H}=−18°), respectively. The height of the ball on the screen was assumed to be h₀=0.5 m.

In one embodiment of the present invention, the coordinates of the golf ball 11 landing location is provided on a simple digital display, and the deviation from the putting-hole location will also be displayed. In yet another embodiment, the calculated ball trajectory will be presented on a computer or TV screen with the background of the green golf course field and the putting-hole location.

### Force Calculation and Sensor Selection:

The maximum force on the sensor 1-8 depends on the mass and the speed of the ball 11. This maximum force value is required in selecting the force sensors which should have the appropriate dynamic range.

In the case of a golf ball, its mass is 45.9 g, which is m=0.0459 kg. The speed of a golf ball is usually not more than 80 miles per hour, which is V₀≦36 m/s. If the golf ball 11 is stopped by the screen 10 within Δt=0.1 seconds, the force exerted on the screen should be,

F=ma=mV₀/0.1≦0.0459×36/0.1=16.5 kg·m/s²=16.5N=1.65 kg Equation (15)

Although there are 8 force sensors 1-8, the force on each force sensor 1-8 is not equal, depending on the position of the ball 11 on the target screen 10. Therefore, the safe estimation for the maximum force on each force sensor should be 1.65 kg, so that it will not be damaged.

### Estimation of Ball Spin:

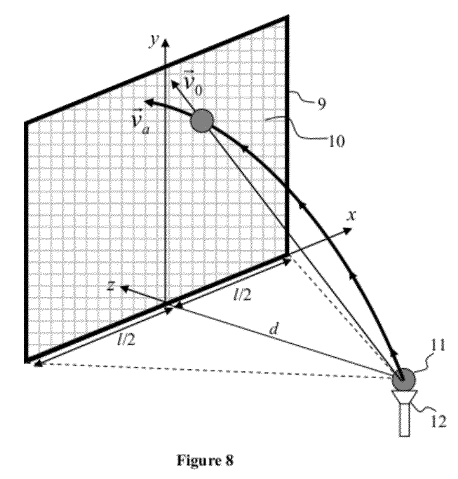

Based on the force measurements from the eight force sensors 1-8, it is possible to determine the full speed vector of a flying ball 11 when it hits the screen 10. However, the spin of the ball 11 cannot be determined by this information alone. If one wants to further determine the spin of the ball, the origin or location of where the ball 11 starts just prior to being hit by a golf club has to be predetermined. As illustrated in FIG. 8, assume the tee 12 is located at a distance d from the bottom center of the target screen 10. If there is no spin, the speed vector of the ball 11 when it hits the target screen 10 can be calculated by drawing a straight line from the location of the tee 12 to the measured ball hitting location on the target screen 10, which is shown as \vec{v}₀ in FIG. 8. If the ball has spin, the trajectory will be curved before hitting the screen and the direction of the speed vector, shown as \vec{v}ₐ in FIG. 8, measured by the force sensors will be different from that of \vec{v}₀. The angular difference between \vec{v}ₐ and \vec{v}₀ can be used to evaluate the speed and the orientation of spin.

It will be appreciated that the mobile ball target screen of the present invention can be used for applications other than golf training and entertainment. Furthermore, the mobile ball target screen can be fabricated in various sizes and from a wide range of suitable components and materials, using various manufacturing and fabrication techniques accommodating different types of balls. Thus, although the invention has been disclosed with reference to various particular embodiments, it is understood that equivalents may be employed and substitutions made herein without departing from the contemplated scope of the invention.

Having thus described the invention, what is claimed as new and desired to be secured by Letters Patent is:

1. A mobile ball target screen and ball trajectory computing system and method comprising:
A closed frame having a plurality of sides, said frame supporting a plurality of sensors optimally positioned around the frame perimeter, said sensors are functionally connected to a target screen such that any force exerted on the target screen will be measured by the sensors, said target screen substantially fills the interior area of the closed frame, a means for individually measuring said plurality of forces measured by the sensors.

2. The mobile ball target screen and ball trajectory computing system of claim 1, wherein the sensors are force sensors.

3. The mobile ball target screen and ball trajectory computing system of claim 1, wherein the frame has four sides, having two sensors operatively affix to orthogonal sides of each corner of the frame.

4. The mobile ball target screen and ball trajectory computing system of claim 1, wherein the frame has four sides having a sensor portion affix to each interior corner of the frame, said sensor portion having a means of measuring two orthogonal forces.

5. A mobile ball target screen and ball trajectory computing system and method comprising; A closed frame having a plurality of sides, said frame supporting a plurality of sensors optimally positioned around the frame perimeter, said sensors are functionally connected to a target screen such that any force exerted on the target screen will be measured by the sensors, said target screen substantially fills the interior area of the closed frame, a means for individually measuring said plurality of forces measured by the sensors;
a method for computing the speed of the ball hitting the target screen;
a method for computing the vertical and horizontal position of the ball on the target screen as the ball hits the target screen;
a method for computing the traveling direction of the ball as the ball hits the target screen;
a method of computing the predicted ball trajectory beyond the target screen;
a means for presenting the predicted ball trajectory.

6. The mobile ball target screen and ball trajectory computing system of claim 5 wherein the sensors are force sensors.

7. The mobile ball target screen and ball trajectory computing system of claim 5, wherein the frame has four sides, having two sensors operatively affix to orthogonal sides of each corner of the frame.

8. The mobile ball target screen and ball trajectory computing system of claim 5, wherein the frame has four sides having a sensor portion affix to each interior corner of the frame, said sensor portion having a means of measuring two orthogonal forces.

9. The mobile ball target screen and ball trajectory computing system of claim 5, wherein the means for presenting the predicted ball trajectory is comprised of a computer monitor.

10. The mobile ball target screen and ball trajectory computing system of claim 5, wherein the means for presenting the predicted ball trajectory is comprised of a hand help computer tablet.

11. A mobile ball target screen and ball trajectory computing system and method comprising; A closed frame having a plurality of sides, said frame supporting a plurality of sensors optimally positioned around the frame perimeter, said sensors are functionally connected to a target screen such that any force exerted on the target screen will be measured by the sensors, said target screen substantially fills the interior area of the closed frame, a means for individually measuring said plurality of forces measured by the sensors;
a method for computing the speed of the ball hitting the target screen;
a method for computing the vertical and horizontal position of the ball on the target screen as the ball hits the target screen;
a method for computing the traveling direction of the ball as the ball hits the target screen;
a method of the computing the predicted ball trajectory information beyond the target screen;
a means for wirelessly communicating the ball trajectory information to a display device;
a means for presenting the predicted ball trajectory information on the display device.

12. The mobile ball target screen and ball trajectory computing system of claim 11, wherein the sensors are force sensors.

13. The mobile ball target screen and ball trajectory computing system of claim 11, wherein the frame has four sides, having two sensors operatively affix to orthogonal sides of each corner of the frame.

14. The mobile ball target screen and ball trajectory computing system of claim 11, wherein the frame has four sides having a sensor portion affix to each interior corner of the frame, said sensor portion having a means of measuring two orthogonal forces.

15. The mobile ball target screen and ball trajectory computing system of claim 11, wherein the mean for presenting the predicted ball trajectory is comprised of a computer monitor.

16. The mobile ball target screen and ball trajectory computing system of claim 11, wherein the mean for presenting the predicted ball trajectory is comprised of a handheld computer tablet.

17. The mobile ball target screen and ball trajectory computing system of claim 11, wherein the mean for presenting the predicted ball trajectory is comprised of a smart phone.

18. The mobile ball target screen and ball trajectory computing system of claim 11, further comprising a method for estimating the ball spin.

19. The mobile ball target screen and ball trajectory computing system of claim 18, wherein the method for estimating ball spin comprises computing the angular difference between a first and a second vectors, the first vector representing the predicted trajectory of a ball without spin traveling from a starting point of where the ball is hit with a golf club to a location measured on the screen in a straight line, the second vector representing a measured direction of flight of the ball at the screen.
